(19) United States
(12) Patent Application Publication
(10) Pub. No.: US 2009/0222447 A1
(43) Pub. Date: Sep. 3, 2009

(54) DATA PROCESSING APPARATUS AND DATA PROCESSING METHOD

(75) Inventor: Noriyoshi Matsumoto, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JustSystems Corporation, Tokushima-shi (JP)

(21) Appl. No.: 12/372,999

(22) Filed: Feb. 18, 2009

(30) Foreign Application Priority Data
Feb. 18, 2008 (JP) 2008-036555

(51) Int. Cl. G06F 7/20; G06F 17/30

(52) U.S. Cl. 707/6; 707/E17.009; 707/E17.014; 715/234

(57) ABSTRACT

A matching device includes a matching unit that selects a pattern consistent with data to be compared, based on a rule by which a correspondence relation between patterns of data described in a markup language is defined; and a variable control unit that substitutes, when a pattern including a variable is selected, the data to be compared located at a position corresponding to a position of the variable in the selected pattern into the variable. The variable control unit substitutes, when the data to be compared is data described in a markup language, and when the data to be compared located at the position corresponding to the position of the variable in the selected pattern, is a fragment including a plurality of nodes, the fragment into the variable.

### BACKGROUND OF THE INVENTION

1. Field of the Invention

The present invention relates to a document processing technique, in particular, to a document processing apparatus and method that process a document described in a markup language.

2. Description of the Related Art

XML attracts attention as a form suitable for sharing data with others via a network etc., and applications for creating, displaying and editing XML documents are developed (for example, see Patent Document 1). An XML document is created based on a vocabulary (tag set) defined by document type definition etc.

[Patent Document 1] Japanese Patent application Laid-open No. 2001-290804.

Any vocabulary can be defined arbitrarily, and therefore infinitely many vocabularies could be available theoretically. The present applicant has developed a technique that can appropriately process an XML document in which flexible document design is possible in this way. And, the applicant has finally contemplated a data processing technique highly convenient due to having XML advantages sufficiently.

### SUMMARY OF THE INVENTION

The present invention has been made in view of these circumstances, and a purpose of the invention is to provide a technique in which a document structured by a markup language is appropriately processed.

An embodiment of the present invention relates to a data processing apparatus. The data processing apparatus comprises: a rule acquisition unit that acquires a rule by which a correspondence relation between a pattern of data described in a markup language and a pattern of data described or not described in a markup language, is defined; a data acquisition unit that acquires data to be compared; and a matching unit that selects a pattern consistent with the data to be compared, wherein the matching unit further comprises a variable control unit that selects, when a variable is included in the pattern, a pattern in which, among the pattern, data other than the variable are consistent with the data to be compared, and that substitutes, when the pattern including the variable is selected, the data to be compared located at a position corresponding to a position of the variable in the selected pattern, into the variable and wherein, when the data to be compared is data described in a markup language, and when the data to be compared located at the position corresponding to the position of the variable in the selected pattern, is a fragment including a plurality of nodes, the variable control unit substitutes the fragment into the variable.

When a plurality of homogeneous or heterogeneous data, which can be substituted into the variable, are located in parallel at the position of the data to be compared, which corresponds to the position of the variable in the selected pattern, the variable control unit may also store the plurality of data in the variable as a list.

When the data to be compared is data described in a markup language, and when a node located at the position of the data to be compared, which corresponds to the position of the variable in the selected pattern, has a plurality of brother nodes, the variable control unit may also store the nodes or a fragment in which the nodes are apex nodes, in the variable as a list.

When the variable is attached with a wild card indicating that the variable is to be matched to a plurality of arbitrary data, the variable control unit may also store the plurality of data thus matched in the variable as a list.

When the variable is attached with a wild card indicating that the variable is to be matched to arbitrary data not including a text node among the fragment, the variable control unit may also substitute data excluding the text data among the fragment thus matched into the variable. And, when the variable is attached with a wild card indicating the variable is to be matched to the arbitrary fragment including a text node as well, the variable control unit may also substitute the fragment thus matched in the variable.

When the matching unit compares elements or attributes described in a markup language to each other, the data processing apparatus may further comprise a namespace control unit that compares namespaces of the elements or the attributes to each other, wherein, when the namespaces of the elements or the attributes are determined not to be consistent with each other by the namespace control unit, the matching unit may determine that the elements or the attributes are not consistent with each other.

The data processing apparatus may further comprise a conversion unit that converts the data to be compared, to data with a pattern corresponding to the selected pattern.

Among the above rule, at least one definition of the correspondence relation may include the same variable in the two corresponding patterns. The data to be compared may be converted to data having a pattern different from that of the data to be compared and including at least part of the data to be compared, by substituting data included in the data to be compared in the variable.

Another embodiment of the present invention relates to a data processing method. The data processing method comprises: acquiring a rule by which a correspondence relation between a pattern of data described in a markup language and a pattern of data described or not described in a markup language, is defined; acquiring data to be compared; selecting a pattern consistent with the data to be compared; selecting a pattern in which, among the pattern, data other than the variable are consistent with the data to be compared, when a variable is included in the pattern; substituting, when the pattern including the variable is selected, the data to be compared located at a position corresponding to a position of the variable in the selected pattern, into the variable; and substituting, when the data to be compared is data described in a markup language, and when the data to be compared located at the position corresponding to the position of the variable in the selected pattern, is a fragment including a plurality of nodes, the fragment into the variable.

It is noted that any combination of the aforementioned components or any manifestation of the present invention exchanged between methods, devices, systems and so forth, is effective as an embodiment of the present invention.

### BRIEF DESCRIPTION OF THE DRAWINGS

FIG. 1 is a diagram showing a configuration of a document processing apparatus according to Base technology;

FIG. 2 is a diagram showing an example of an XML document that is a processing target;

FIG. 3 is a diagram showing an example in which the XML document shown in FIG. 2 is mapped to a table described in HTML;

FIG. 4A is a diagram showing an example of a definition file used for mapping the XML document shown in FIG. 2 to the table shown in FIG. 3;

FIG. 4B is a diagram showing an example of a definition file used for mapping the XML document shown in FIG. 2 to the table shown in FIG. 3;

FIG. 5 is a diagram showing an example of a screen on which the XML document shown in FIG. 2 is displayed after having been mapped to HTML according to the correspondence shown in FIG. 3;

FIG. 6 is a diagram showing an example of a graphical user interface provided by a definition file creating unit, which allows the user to create a definition file;

FIG. 7 is a diagram showing another example of a screen layout created by the definition file creating unit;

FIG. 8 is a diagram showing an example of an editing screen for an XML document, as provided by the document processing apparatus;

FIG. 9 is a diagram showing another example of an XML document that is to be edited by the document processing apparatus;

FIG. 10 is a diagram showing an example of a screen on which the document shown in FIG. 9 is displayed;

FIG. 11 is a diagram showing a configuration of the document processing apparatus according to the first embodiment;

FIG. 12 is a diagram showing an example of a program code;

FIG. 13 is a diagram showing an example of a source document;

FIG. 14 is a diagram showing a destination document created by converting the source document shown in FIG. 13 with the program shown in FIG. 12;

FIG. 15 is a diagram showing an example of a screen on which the destination document shown in FIG. 14 is displayed;

FIG. 16 is a diagram showing a configuration of the document processing apparatus according to the second embodiment; and

FIGS. 17A to 17C are diagrams showing examples of a program code described in a syntax according to the second embodiment.

### DETAILED DESCRIPTION OF THE INVENTION

The invention will now be described by reference to the preferred embodiments. This does not intend to limit the scope of the present invention, but to exemplify the invention.

### (Base Technology)

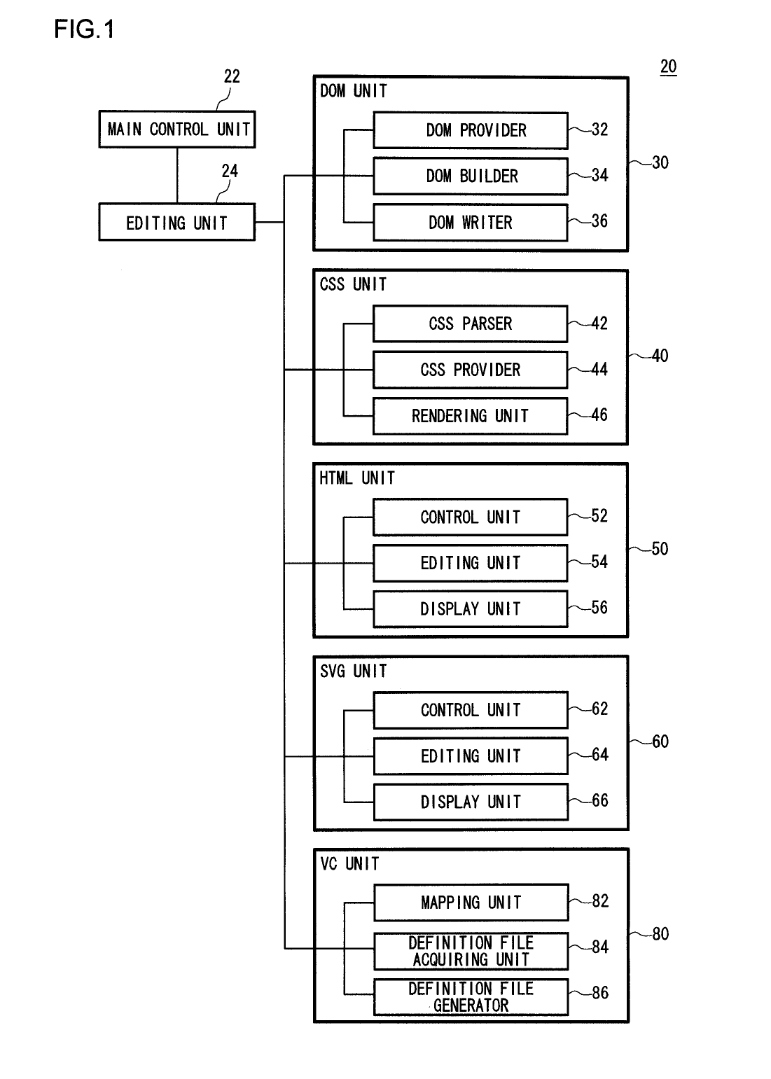

FIG. 1 shows a configuration of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 that serves as an example of a conversion unit. In terms of hardware components, these unit structures may be realized by any conventional processing system or equipment, including a CPU or memory of any computer, a memory-loaded program, or the like. Here, the drawing shows a functional block configuration that is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a namespace of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above configuration, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this configuration is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC) In the VC unit 80, the definition file acquiring unit 84 acquires a script file in which the mapping definition is described. Here, the definition file specifies the correspondence (connection) between the nodes for each node. Furthermore, the definition file may specify whether or not editing of the element values or attribute values is permitted. Furthermore, the definition file may include operation expressions using the element values or attribute values for the node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface that allows the user to create a definition file.

The VC unit 80 monitors the connection between the source tree and the destination tree. Upon reception of an editing instruction from the user via a user interface provided by a plug-in that handles a display function, the VC unit 80 first modifies a relevant node of the source tree. As a result, the DOM unit 30 issues a mutation event indicating that the source tree has been modified. Upon reception of the mutation event thus issued, the VC unit 80 modifies a node of the destination tree corresponding to the modified node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a namespace of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary that is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

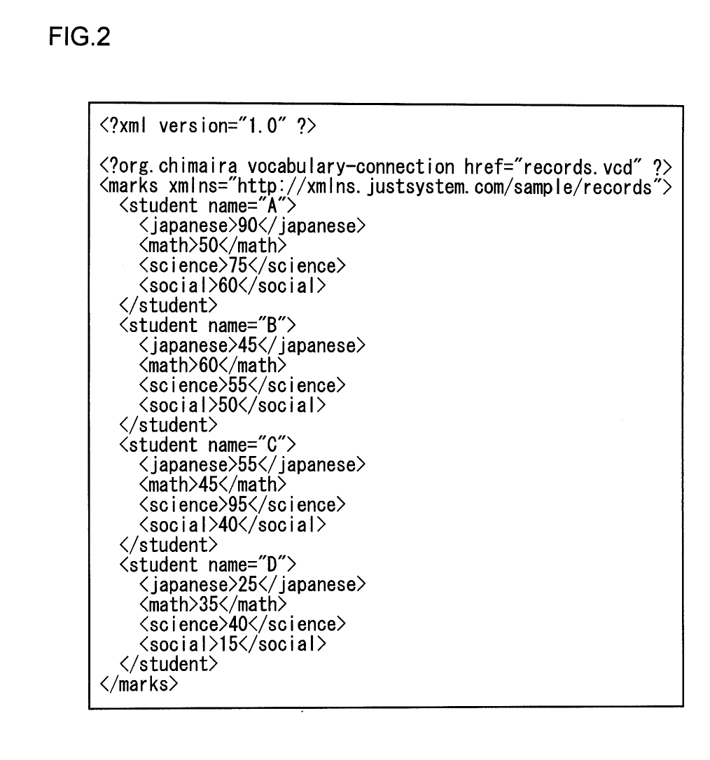

FIG. 2 shows an example of an XML document to be processed. According to this exemplary illustration, the XML document is used to manage data concerning grades or marks that students have earned. A component “marks”, which is the top node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. It is noted that description will be made later regarding a user interface that allows the user to create the user's own definition file. Now, description will be made below regarding a case in which a definition file has already been prepared.

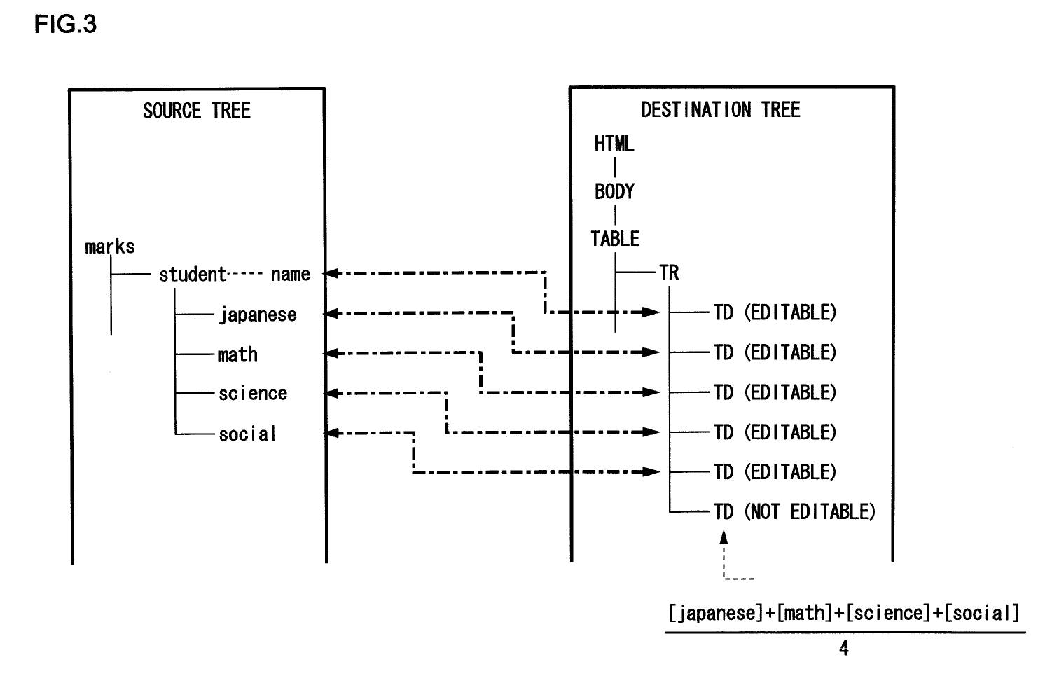

FIG. 3 shows an example in which the XML document shown in FIG. 2 is mapped to a table described in HTML. In an example shown in FIG. 3, a “student” node in the marks managing vocabulary is associated with a row (“TR” node) of a table (“TABLE” node) in HTML. The first column in each row corresponds to an attribute value “name”, the second column to a “japanese” node element value, the third column to a “mathematics” node element value, the fourth column to a “science” node element value and the fifth column to a “social_studies” node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

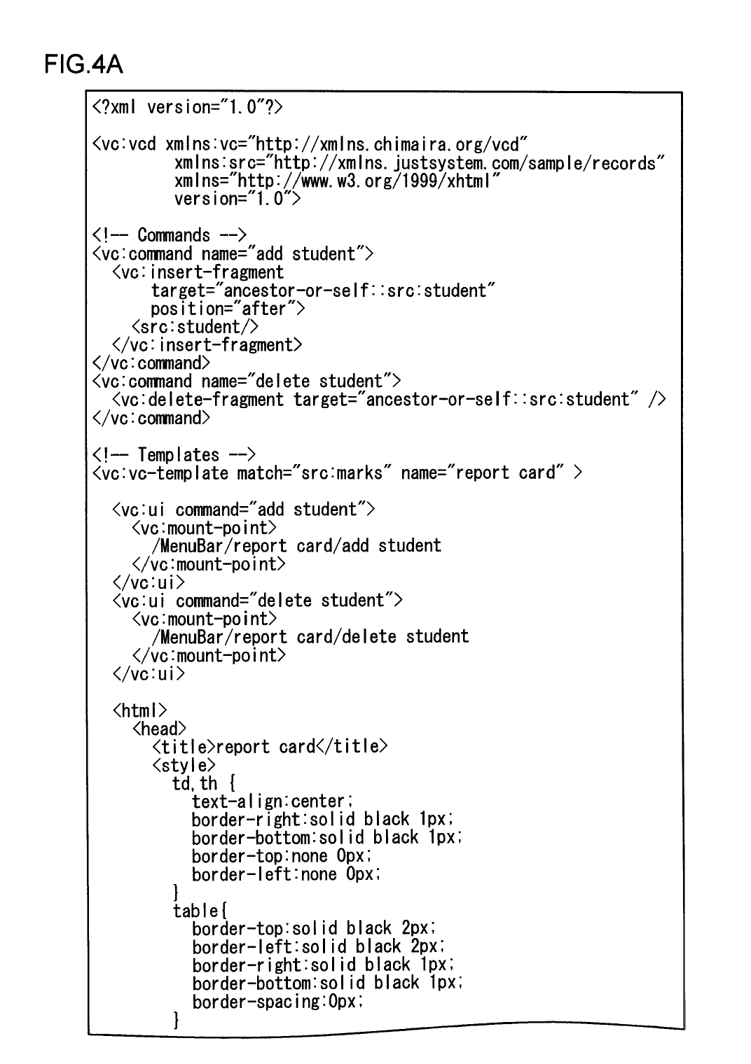

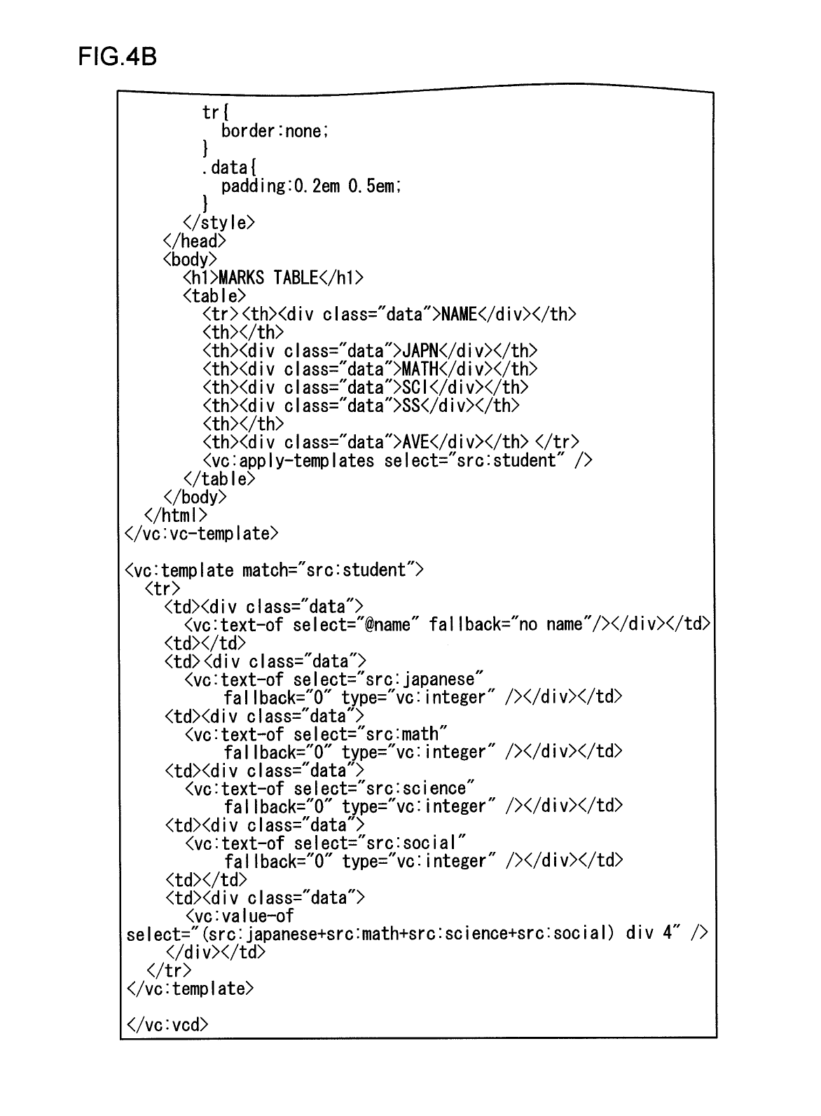

FIG. 4A and FIG. 4B illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4A and FIG. 4B, “add student” and “delete student” are defined as commands, and an operation of inserting a node “student” into a source tree and an operation of deleting the node “student” from the source tree, respectively, are associated with these commands. Furthermore, the definition file is described in the form of a template, which describes that a header, such as “name” and “japanese”, is displayed in the first row of a table and the contents of the node “student” are displayed in the second and subsequent rows. In the template displaying the contents of the node “student”, a term containing “text-of” indicates that editing is permitted, whereas a term containing “value-of” indicates that editing is not permitted. Among the rows where the contents of the node “student” are displayed, an operation expression “(src:japanese+src:mathematics+scr:science+scr:social_studies) div 4” is described in the sixth row. This means that the average of the student's marks is displayed.

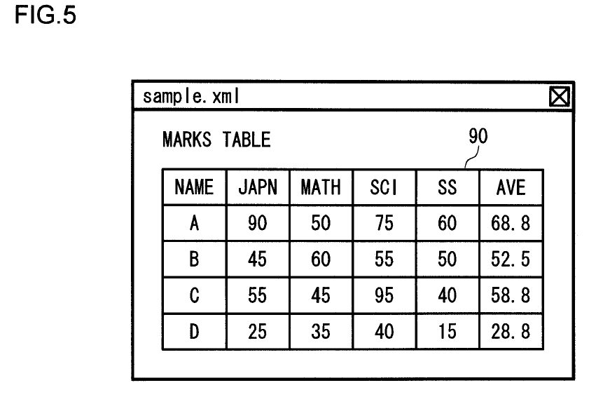

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4A and FIG. 4B. When the user selects a command from among these commands, a node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

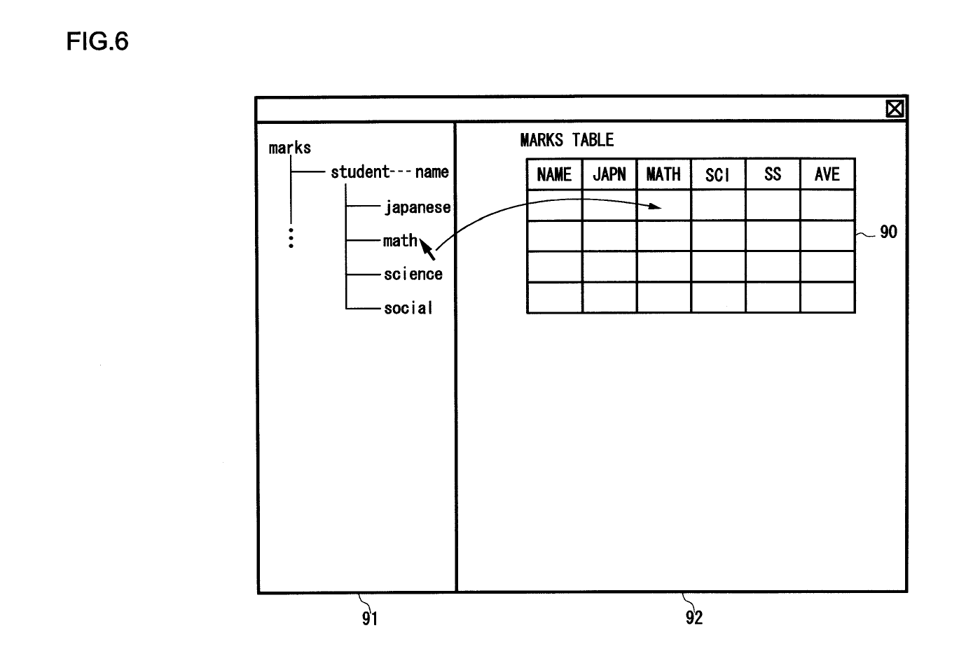

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a node of the XML document that is to be mapped, which is displayed in the left-hand area 91 of the screen, is dragged and dropped into HTML screen layout in the right-hand area 92 of the screen using a pointing device such as a mouse, so that a connection between a node at a mapping source and a node at a mapping destination is specified. For example, when “mathematics,” which is a child element of the element “student,” is dropped to the intersection of the first row and the third column in a table 90 on HTML screen, a connection is established between the “mathematics” node and a “TD” node in the third column. Either editing or no editing can be specified for each node. Moreover, the operation expression can be embedded in a display screen. When the screen editing is completed, the definition file generator 86 creates definition files, which describe connections between the screen layout and nodes.

Viewers or editors that can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

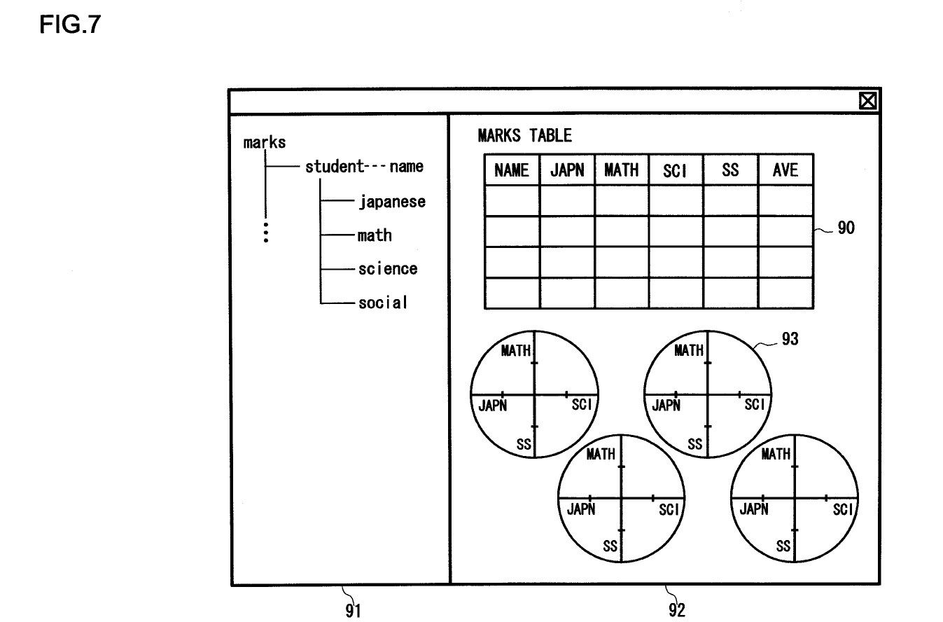

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

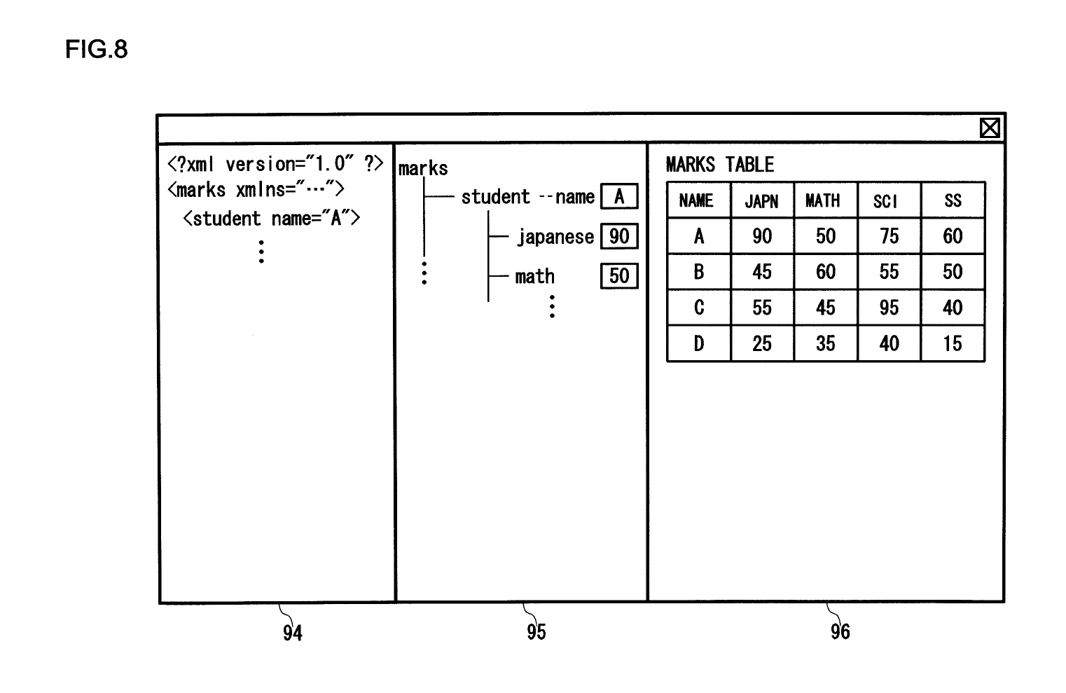

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

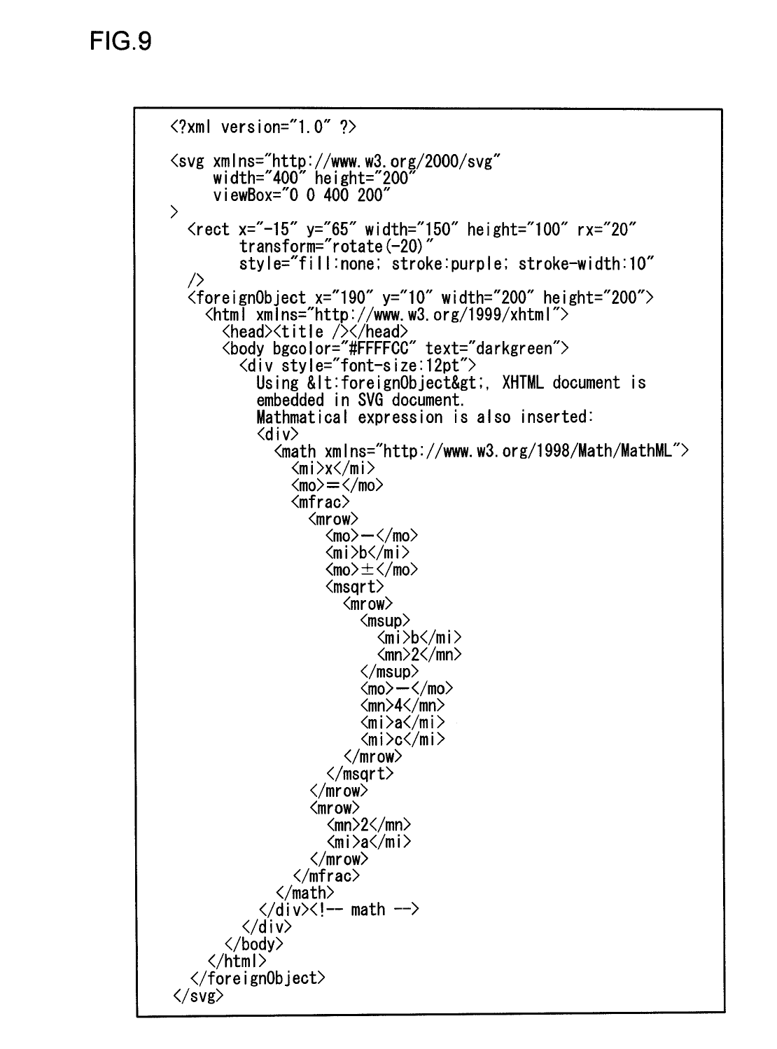

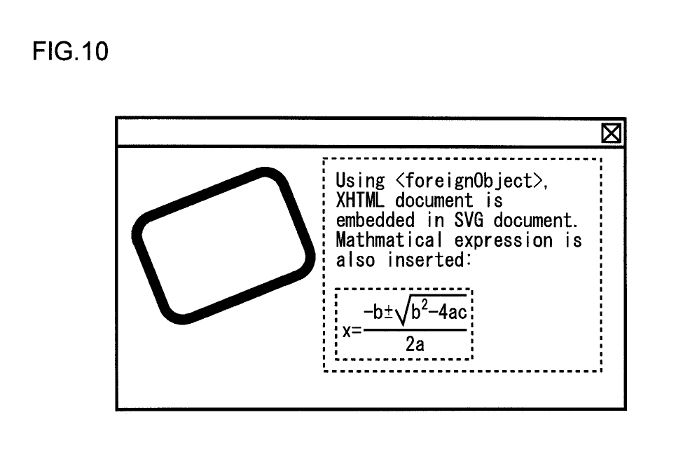

FIG. 9 illustrates another example of an XML document edited by the document processing apparatus 20. In the XML document shown in FIG. 9, an XHTML document is embedded in a “foreignobject” tag of an SVG document, and the XHTML document contains an equation described in MathML. In this case, the editing unit 24 assigns the rendering job to an appropriate display system by referring to the namespace. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set that is defined in the definition file for mapping the SVG document, is displayed. On the other hand, when the cursor lies in an area where the XHTML document is displayed, the menu provided by HTML unit 50, or a command set that is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each node in the source tree. Normally, a display unit of the plug-in or the VC unit 80 conforming to a vocabulary that belongs to each node is registered as the listener. When the source tree is modified, the DOM provider 32 traces toward a higher hierarchy from the modified node. If there is a registered listener, the DOM provider 32 issues a mutation event to the listener. For example, referring to the document shown in FIG. 9, if a node that lies lower than the <html> node is modified, the mutation event is notified to HTML unit 50, which is registered as a listener to the <html> node. At the same time, the mutation event is also notified to the SVG unit 60, which is registered as a listener in an <svg> node, which lies upper to the <html> node. At this time, HTML unit 50 updates the display by referring to the modified source tree. Since the nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest node, in increments of display regions that are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### First Embodiment

The vocabulary connection function described in Base Technology has been realized by using the definition file described in a language derived from expanding XSLT, as shown in FIG. 4. In the present embodiment, a technique will be described below in which a correspondence relation between XML data and XML data or other data is represented more flexibly, such that conversion and reverse conversion between those data, and verification of the correspondence relation, can be realized.

XSLT is a language for converting a document described in XML to a document described in another XML. XSLT has directionality in conversion, and hence it is needed to define the procedures of reverse conversion separately when there is a need for the reverse conversion. For example, after a document described in vocabulary that is not implemented is converted to a document described in vocabulary that is implemented by using XSLT, the document thus converted can be edited by the processing system; however, reverse conversion is needed in order to reflect the editing on the original document. However, if arbitrary editing of the document thus converted is allowed, it becomes difficult to maintain the consistency with the original document.

In Base Technology, the above problem has been solved by using a technique described below in which editing is performed while maintaining the consistency between the original document and the document to be converted: a configuration is provided by which a correspondence relation between nodes in the definition of the forward conversion is monitored; an editing operation for editing the original document is received on an editing screen on which the document to be converted is displayed; and the original document is at first updated, and then the update is reflected on the document to be converted via the configuration for monitoring the correspondence relation.

However, there is another problem in XSLT. The problem is that a correspondence relation between XML fragments including a plurality of nodes cannot be represented, because XSLT can only perform processing based on a single XML structure. Therefore, the present embodiment presents a technique in which a correspondence relation between data can be represented more flexibly by making an XML fragment algebraic in order to allow a correspondence relation between data including the algebraic XML fragment to be defined, such that conversion and reverse conversion between those data, and verification of the correspondence relation, can be realized.

As a programming language suitable for defining a correspondence relation between data, and for performing pattern matching based on the correspondence relation therebetween, for example, Prolog (Programming in Logic), a programming language based on the first-order predicate logic, or the like, exists. However, the pattern matching of the Prolog matches code patterns, which is not suitable for handling XML fragments as it is. For example, when comparing element names one to another, matching thereof sometimes fails although the element names actually have the same namespaces, because they are described by using different namespace prefixes, resulting in the fact that they are not consistent with each other as character strings. Or, in the case where an element can include a plurality of attributes, matching thereof sometimes fails, because the attributes are described in an order different from that defined in the rule, although the order of describing the attributes is actually meaningless. In order to succeed in matching of attributes no matter what order the attributes are described in, it is needed to define all assumed orders of the attributes in advance, resulting in huge complexity. The present embodiment adopts a notation system in which any XML fragment can be specified uniquely in compliance with such XML characteristics.

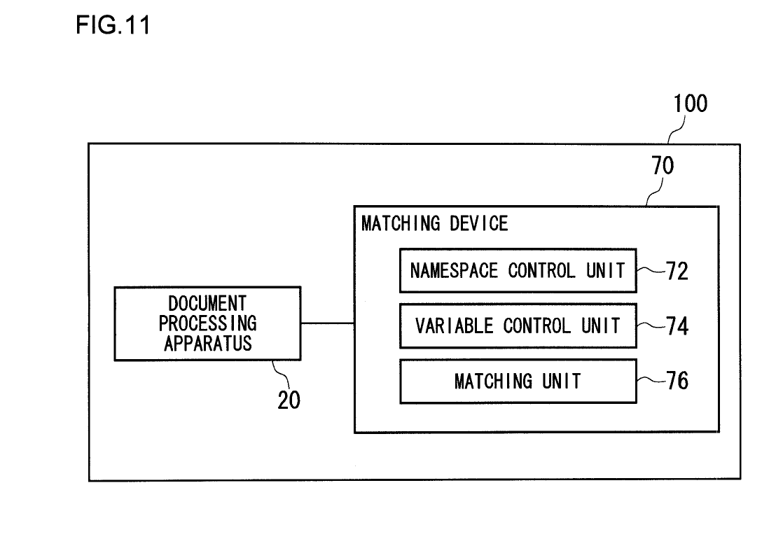

FIG. 11 shows a configuration of the document processing apparatus according to the first embodiment. The document processing apparatus 100 according to the first embodiment further comprises a matching device 70 in addition to the configuration of the document processing apparatus 20 in Base Technology shown in FIG. 1. The matching device 70 includes a namespace control unit 72, a variable control unit 74, and a matching unit 76. Other configurations and operations thereof are the same as Base technology.

The matching device 70 processes data to be compared while searching for a pattern consistent with the data to be compared, based on a rule by which a correspondence relation between a pattern of data described in a markup language and a pattern of data described or not described in a markup language, is defined. The matching device 70 may also be an implementation in which processing is executed sequentially in accordance with a code described in a programming language, such as Prolog; or also be an implementation in which a code described in a programming language is compiled.

The matching unit 76 selects a pattern consistent with the data to be compared, among the rules by which a correspondence relation between patterns of data is defined. When a variable is included in a pattern, the matching unit 76 selects a pattern in which, among the pattern, data other than the variable are consistent with the data to be compared.

When a pattern including a variable is selected by the matching unit 76, the variable control unit 74 substitutes the data to be compared located at a position corresponding to a position of the variable in the selected pattern, into the variable. When the data to be compared is data described in a markup language, and when the data to be compared located at the position corresponding to the position of the variable in the selected pattern, is a fragment including a plurality of nodes, the variable control unit 74 substitutes the fragment into the variable.

When a plurality of homogeneous data are located in parallel at the position of the data to be compared, which corresponds to the position of the variable in the selected pattern, the variable control unit 74 stores the plurality of data in the variable as a list. In particular, when the data to be compared is data described in a markup language, and when a node located at the position of the data to be compared, which corresponds to the position of the variable in the selected pattern, has a plurality of brother nodes, the variable control unit 74 stores the nodes or a fragment in which these nodes are apex nodes, in the variable as a list.

When the matching unit 76 compares elements or attributes described in a markup language to one another, the namespace control unit 72 compares the namespaces of the elements or the attributes to each other. The namespace control unit 72 holds a relation between a namespace prefix and a namespace URI, which are declared in a document. The namespace control unit 72 determines whether the namespaces of the elements or the attributes are consistent with each other by converting the namespace prefixes added to the elements or the attributes to namespace URIs, and by comparing the namespace URIs to one another. That is, even if namespace prefixes are different from each other, the namespaces thereof are determined to be consistent with each other, when the namespaces are associated with the same namespace URI. Conversely, even if namespaces are added with the same namespace prefix, the namespaces are determined not to be consistent with each other, when the namespaces are associated with different namespace URIs, respectively. When the namespaces of elements or attributes are determined not to be consistent with each other by the namespace control unit 72, the matching unit 76 determines that the elements or the attributes are not consistent with each other.

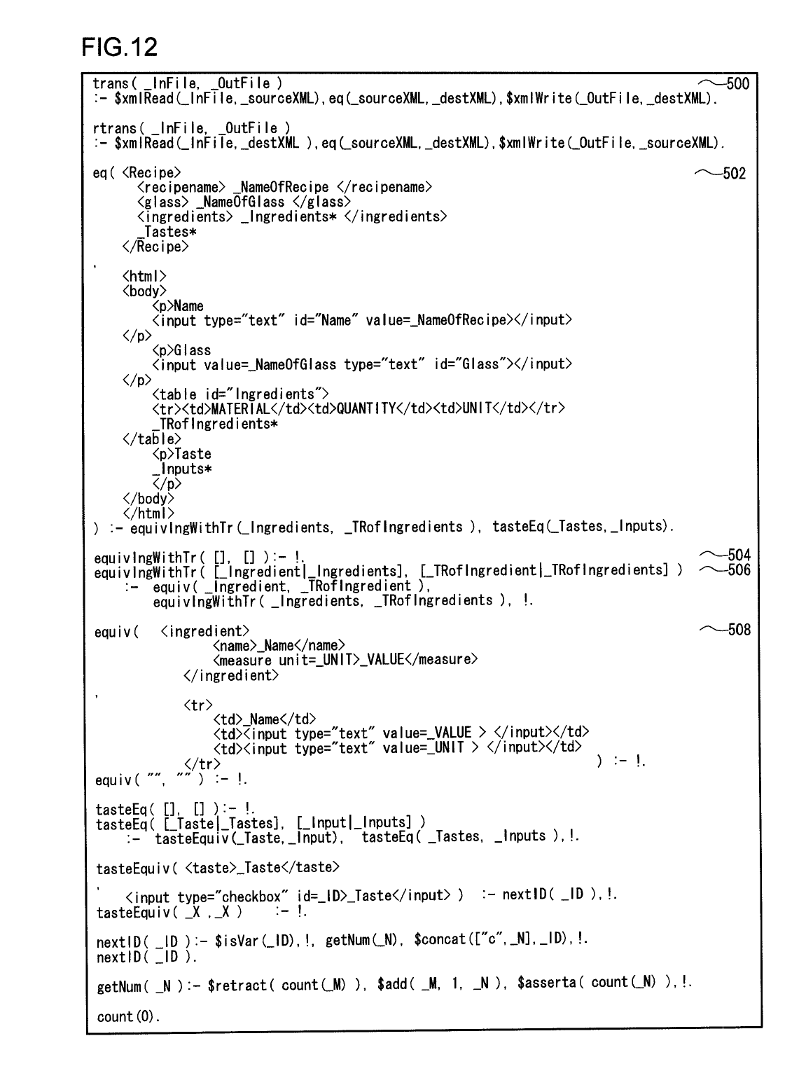

FIG. 12 shows an example of a program code by which an XML document is converted. In the program shown in FIG. 12, a rule defining a correspondence relation between data is described by the same notation system as Prolog. As stated above, expansion of the program is made in order to handle an XML fragment. For example, when a wild card “*” is attached to a variable as a postfix, the matching unit 76 matches the variable to a plurality of arbitrary XML fragments irrespective of the number, order, and type of the fragment. At the time, the variable control unit 74 substitutes the plurality of XML fragments thus matched into the variable as a list. When the wild card “+” is attached to a variable as a postfix, the matching unit 76 matches the variable to any XML fragment including a text node. At the time, the variable control unit 74 substitutes the XML fragment thus matched into the variable. When a wild card “-” is attached to a variable as a postfix, the matching unit 76 matches the variable to any XML fragment excluding a text node. At the time, the variable control unit 74 substitutes the data excluding the text node among the XML fragment thus matched, into the variable. In the case of a document-type XML fragment, all nodes including a text node are substituted into the variable to which a postfix “+” is attached. On the other hand, all nodes excluding a text node are substituted into variable to which a postfix “−” is attached.

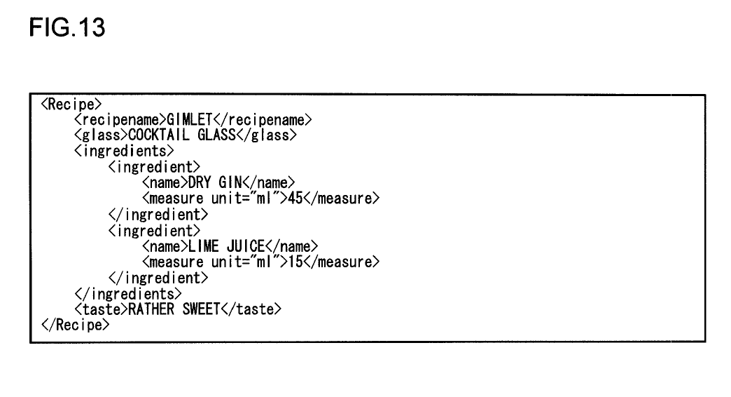

FIG. 13 shows an example of a source document. The document shown in the drawing is described in vocabularies for describing recipes of cocktails. In FIG. 13, declaration of a namespace is omitted; however, it is assumed that the declaration thereof is made in the document. In the document, the element “recipename” in which the name of a recipe is stored, the element “glass” in which a type of a glass is stored, the element “ingredients” in which materials are stored, and the element “taste” in which a type of the taste is stored, are described below the apex element “Recipe”. The element “ingredients” includes one or more of the element “ingredient” for every type of the materials, and each element “ingredient” includes the element “name” in which the name of a material is stored, and the element “measure” in which a quantity of a material is stored. The element “measure” includes the attribute “unit” in which the unit of a quantity is stored.

Herein, performance of the matching device 70 in which the device 70 converts the source document shown in FIG. 13 by using the definition shown in FIG. 12, will be described in detail. When the matching device 70 receives a question for forward conversion “trans (input file name, output file name)”, the matching unit 76 searches for a fact or rule consistent with the question, and then selects the rule 500 “trans (_InFile, _OutFile)”. At the time, the variable control unit 74 substitutes the input file name designated by the first argument of the question, into the free variable “InFile”, and substitutes the output file name designated by the second argument into the free variable “OutFile”.

Subsequently, the matching device 70 executes the first goal of the rule 500, and loads the designated input file. Herein, the source document shown in FIG. 13 is loaded. At the time, the DOM builder creates a source DOM from the document thus loaded. The variable control unit 74 substitutes the source DOM thus created into the free variable “_sourceXML”.

Subsequently, the matching device 70 executes the second goal of the rule 500, “eq(_sourceXML,_destXML)”. The matching unit 76 compares the source DOM stored in the variable “_sourceXML” to the first argument in the head of the rule 502. When matching of the portion other than the free variable is performed successfully, that is, when the source DOM has the same structure as the XML fragment described in the first argument in the head of the rule 502, the matching unit 76 selects the rule 502. At the time, the variable control unit 74 substitutes an XML fragment located at the relevant position in the source DOM, into each free variable.

The source document shown in FIG. 13 has the same structure as the first argument in the head of the rule 502, and therefore the matching unit 76 selects the rule 502. The variable control unit 74 substitutes the character string “gimlet” into the free variable “NameOfRecipe”, the character string “cocktail glass” into the free variable “_NameOfGlass”, an XML fragment located below the element “ingredients” into the free variable “_Ingredients”, and an XML fragment described after the element “ingredients” into the free variable “_Taste”. Herein, the wild card “*” is attached to the free variable “_Ingredients” as a postfix, and two elements “ingredient” are described below the element “ingredients” in the source document shown in FIG. 13; hence the variable control unit 74 stores two XML fragments in which these elements “ingredients” are apex nodes, in the free variable “_Ingredients” as a list.

In addition, the variable control unit 74 substitutes the XML fragment described in the second argument in the head of the rule 502 into the free variable “_destXML”. At the time, in the XML fragment described in the second argument, the same variable as that included in the XML fragment described in the first argument, for example, the variable “_NameOfRecipe” or the like, is included; therefore, part of the data in the source document shown in FIG. 13 is reflected within the destination document. The variable “_TRofIngredients” and the variable “_Input” included in the XML fragment described in the second argument are not yet substituted by values.

Subsequently, the matching device 70 executes the first goal of the rule 502, “equivIngWithTr (_Ingredients, _TRofIngredients)”. The matching unit 76 compares the first argument in the head of the rule 504 to the variable “_Ingredients”; however, the matching to the rule 504 fails because the variable “_Ingredients” is not an empty list. The matching unit 76 subsequently compares the first argument in the head of the rule 506 to the variable “_Ingredients”. The matching unit 76 succeeds in the matching to the rule 506 because the variable “_Ingredients” is a list; and the variable control unit 74 substitutes the first XML fragment of the variable “_Ingredients” into the variable “_Ingredient”, and substitutes the remains into the variable “_Ingredients”.

Subsequently, the matching device 70 executes the first goal of the rule 506, “equiv (_Ingredient,_TRofIngredient)”. The matching unit 76 compares the XML fragment stored in the variable “_Ingredient” to the first argument in the head of the rule 508. In the variable “_Ingredient”, an XML fragment in which, of the two elements “Ingredient” in the source document shown in FIG. 13, the first element “Ingredient” is an apex node, is currently stored; hence the matching unit 76 succeeds in the matching to the rule 508. The variable control unit 74 substitutes the character string “dry gin” into the free variable “_Name”, the character string “ml” into the free variable “_UNIT”, and the character string “45” into the free variable “_VALUE”.

The variable control unit 74 further substitutes the second argument in the head of the rule 508 into the free variable “_TRofIngredient”, the second argument of the first goal of the rule 506 by which the rule 508 is called. At the time, in the variables “_Name”, “_VALUE” and “_UNIT” that are described in the second argument of the rule 508, data extracted from the source document are already stored. In this way, an XML fragment in which the XHTML element “tr” is an apex is created from the fragment in which the element “Ingredient” in the source document is an apex. A cut is described in the main body of the rule 508, and hence the matching device 70 finishes the execution of the first goal of the rule 506, and executes the second goal.

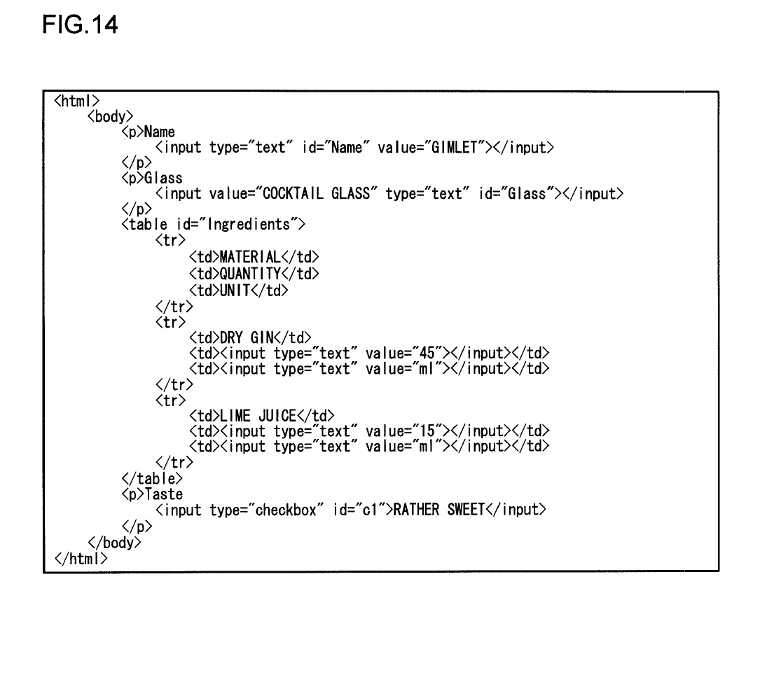

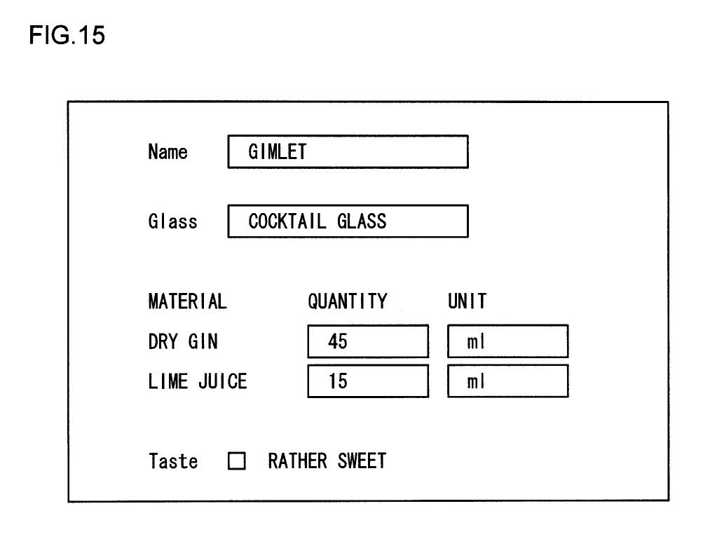

In the second goal of the rule 508, “equivIngWithTr (_Ingredients, _TRofIngredients)” are called recursively. In this way, all XML fragments stored in the variable “_Ingredients” are processed. When the list of the variable “_Ingredients” is finally empty, the rule 504 is selected. As a cut is described in the main body of the rule 504, the matching device 70 finishes the execution of the first goal of the rule 502. In this way, the XML fragment created from the XML fragment stored in the variable “_Ingredients” is substituted into the variable “_TRofIngredients” included in the variable “_destXML”. Likewise, an XML fragment with a different pattern is created from the XML fragment stored in the variable “_Tastes” by executing the second goal of the rule 502, and the created fragment is stored in the variable “Inputs”. Finally, the third goal of the rule 500 is executed such that the XML fragment stored in the variable “_destXML” is written in the output file. A destination document thus created is shown in FIG. 14. In addition, an example of a screen on which the destination document is displayed by the HTML unit 50, is shown in FIG. 15.

In order to execute reverse conversion, a question for the reverse conversion, “rtrans (input file name, output file name)”, is to be executed by the matching device 70. The matching device 70 can execute reverse conversion by using the rule shown in FIG. 12 in the same procedures as the forward conversion stated above. Also in the same way, the matching device 70 can verify whether an XML document has an XML fragment with a pattern described in the rule, allowing validation of the XML document to be performed.

### Second Embodiment

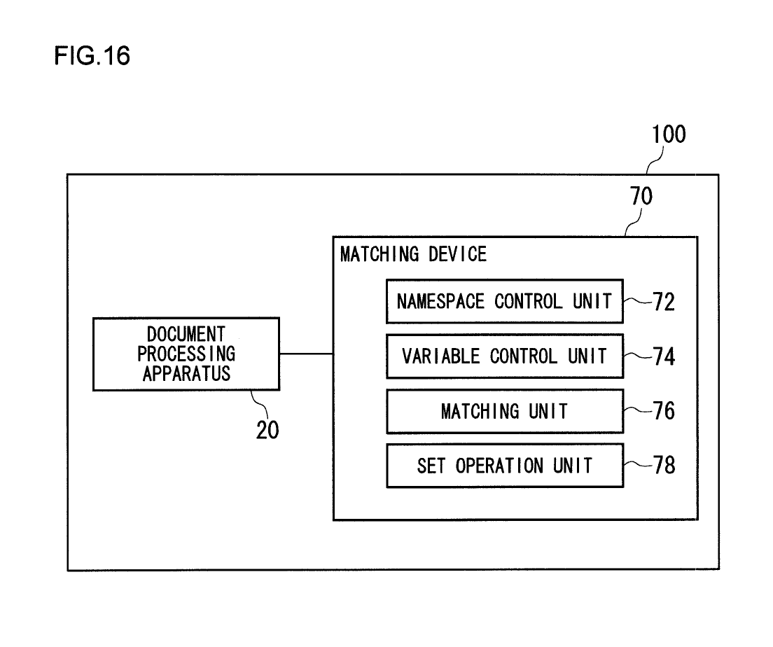

FIG. 16 shows the configuration of the document processing apparatus according to the second embodiment. The document processing apparatus 100 according to the second embodiment further comprises a set operation unit 78 in addition to the configuration of the document processing apparatus 100 according to the first embodiment shown in FIG. 11. As will be described later, the set operation unit 78 executes an operation described in a new syntax, which is added in order to simply describe processing to be executed in common for each value in the variable in which a set of a plurality of values is stored. Other configurations and operations are the same as with the Base Technology.

In the first embodiment, a program is described by using recursion in order to process each of a plurality of values included in a list. Specifically, in order to convert the list of XML fragments stored in the variable “_Ingredients” to HTML fragments, the program in FIG. 12 describes how the result of all XML fragments included in a list being converted to HTML fragments is stored in the variable “_TRofIngredients” as a list. The processing is as follows: in the head of the “equivIngWithTr” of the rule 506, the head value of the list is taken out to the variable “_Ingredient”; the “equiv” of the rule 508 is called at the first goal to convert the head value; the converted HTML fragment is stored in the head value of the variable “_TRofIngredients”; and the above processing is repeated recursively for the remaining values of the list.

As seen above, there are many cases where a common processing is executed for all values included in a list; hence, it is very convenient to prepare a simpler syntax for realizing such processing, when describing a program and when analyzing or verifying a program. Accordingly, the present embodiment adds a new syntax in order to simply describe common processing to be executed for a variable in which a set of a plurality of values is stored. The syntax is shown as follows:

_X[*|+|−|][:Op[->_Y[̂Directive]]]

where, “:” is an operation specifier for a list stored in the variable “_X”; “Op” is an operation (predicate) for subjecting a list stored in the variable “_X” to processing; “_>” is an operation for building the result of the “Op” to produce a list to be bound to the variable “_Y”; “̂” is a specifier for the operation of the “Op”; and the “Directive” specifies a direction for the performance of the “Op”. The specification is made for specifying a direction with respect to performance of the set operation unit 78, and has no effect on the operation result. For example, multiplicity of execution of the processing “Op” in parallel, can de described by “#n”. When multiplicity of the processing is described, the set operation unit 78 executes the processing in parallel as many as described in multiplicity. In addition, a condition for initiating execution of the processing “Op” can be described by “Wait (Condition)”. When the condition “Wait (_Status)” is described, the set operation unit 78 initiates execution of the processing “Op” after waiting until the “_Status” is bound.

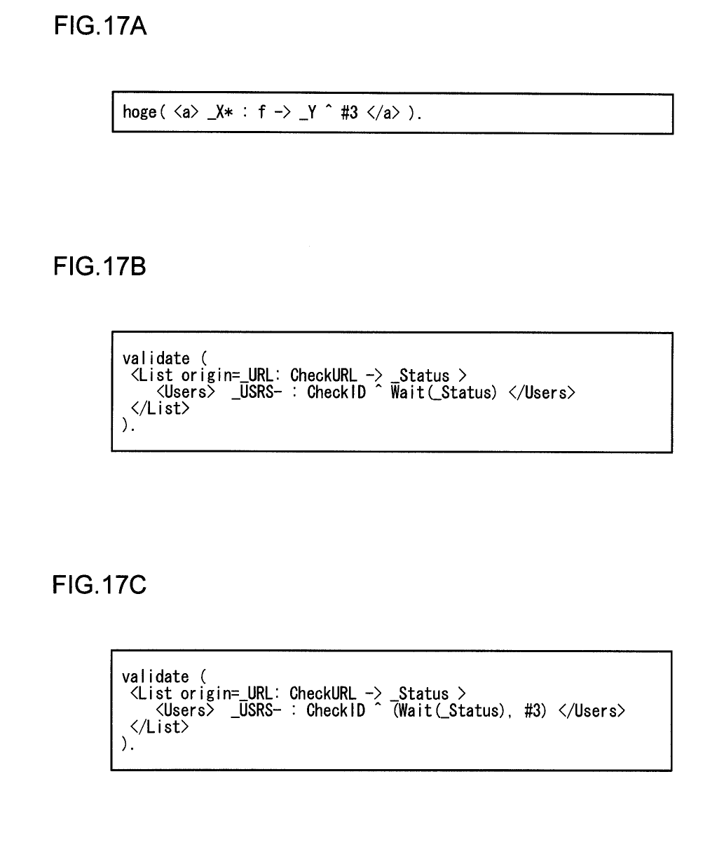

Examples of program codes described in this syntax are shown in FIGS. 17A to 17C. In the program shown in FIG. 17A, upon executing the “hoge (argument)”, the matching unit 76 at first compares the XML fragment designated by the argument to the XML fragment described in the argument in the head of the rule “hoge”, and then selects the rule “hoge” shown in FIG. 17A, if the two XML fragments have the same configuration, that is, the apex element of the XML fragment designated by the argument is “a”. At the time, the variable control unit 74 substitutes the XML fragment located below the element “a” into the variable “_X”. As “*” is added to the variable “_X” as a postfix, the variable control unit 74 stores, when a plurality of XML fragments are located below the element “a”, each of the XML fragments in the variable “_X” as a list, as stated above.

In the rule “hoge”, it is specified that the processing “f” is executed for each of a plurality of values included in the list of the variable “_X”, and that the result of the processing is built as a list to be bound to the variable “_Y”. Accordingly, the set operation unit 78 at first executes the processing “f” for the head value of the list of the variable “_X”, and stores the result of the processing as the head value of the list of the variable “_Y”. Subsequently, the processing “f” is sequentially executed for each value of the list of the variable “_X” in the same way, such that the list of the variable “_Y” is built.

Herein, in the rule “hoge”, the processing “f” is specified so as to be executed with the multiplicity thereof being “3” upon executing the processing “f”. Accordingly, the set operation unit 78 executes the processing “f” for three values simultaneously in parallel. That is, when at first initiating execution of the processing “f” for the first value, the set operation unit 78 initiates execution of the processing “f” for the second and third values without waiting until the first execution is completed, allowing three processes to be executed simultaneously in parallel. When any one of the three processes is completed, the set operation unit 78 initiates the processing “f” for the fourth value. As seen above, the set operation unit 78 controls the processing such that three processes are executed in parallel. Thereby, the processes can be executed efficiently, allowing the time needed for the processing to be shortened. In addition, convenience of a developer can be improved by preparing a syntax in which multiplicity of processing can be simply specified.

When executing processing in parallel with the specified multiplicity as stated above, the set operation unit 78 may determine whether it is proper to execute the processing in parallel, taking into account the availability of the CPU and an amount of space of the memory in the computer, which realize the document processing apparatus 100. For example, after initiating execution of the first processing, the set operation unit 78 may control the processing before executing the second processing, such that, taking into account the capacity of the memory and the availability of the CPU needed for execution of the first processing, and the current amount of space of the memory and the availability of the CPU or the like, execution of the second processing is not initiated until the sufficient resource is secured, when that is not secured. Thereby, the multiplicity of the parallel processing can be adjusted appropriately in accordance with an environment of executing a program.

In the program shown in FIG. 17B, when the rule “validate” is called, the matching unit 76 selects the rule “validate”. The variable control unit 74 stores, among the XML fragments designated by an argument, the value of the attribute “origin” of the element “List” in the variable “_URL”, and stores, among a plurality of child elements that the child element “Users” of the element “List” has, data other than a text node in the variable “_USRS” as a list.

In the rule “validate”, it is specified that the processing “CheckURL” is executed for the value of the variable “_URL”, and the result of the processing is bound to the variable “_Status”. It is also specified that the processing “CheckID” is executed for each value included in the list of the variable “_USRS”. Herein, it is specified that the processing “CheckID” is not executed until the variable “_Status” is bound. Accordingly, the set operation unit 78 initiates execution of the processing “CheckID” for the variable “_USRS” after waiting until the value of the variable “_Status” is fixed following the success of execution of the processing “CheckURL” for the variable “_URL”.

As seen above, convenience of a developer can be improved by preparing a syntax in which a condition for initiating processing can be simply specified. In addition, by describing a condition for initiating processing for a variable in which a set is stored, as well as describing the processing for the variable, in a pattern described in a markup language, association whereby completion of processing is specified as a condition for initiating another processing can be checked appropriately, when parsing a described program. Also, occurrence of a deadlock or the like can be detected appropriately and easily.

In the program shown in FIG. 17C, it is specified that the processing “CheckID” in the program shown in FIG. 17B is executed in parallel with the multiplicity thereof being “3”. When the value of the variable “_Status” is fixed after the processing “CheckURL” is completed, the set operation unit 78 executes the three “CheckID” processes in parallel. And thereafter, when any one of the “CheckID” processes in execution is completed, the set operation unit 78 initiates a new “CheckID” process replacing it.

As seen in the above example, according to the syntax used in the present embodiment, when describing common processing for a set of a plurality of values, it is not needed to describe the processing separately, but one can describe it collectively. That is, a code for taking out a value from a plurality of values, or a code for calling a rule recursively, is not needed to be described. The syntax has a form in which processing for a variable in which a set of a plurality of values is stored, is directly described, allowing the convenience in developing or maintaining a program to be improved.

In the above example, the set operation unit 78 executes an operation for a set after construing the above syntax. In another example, the set operation unit 78 may convert the above syntax to a program code using a syntax with a conventional form after construing the above syntax, the program code realizing the processing for each value included in a list by using recursive call as shown in FIG. 12. In this case, an operation is executed during the execution of the program in the same way as with the first embodiment.

The present invention has been described above in conjunction with the embodiments thereof. The embodiment has been given solely by way of illustration, and it will be understood by a person skilled in the art that various modifications may be made to combinations of the foregoing components and processes, and all such modifications are also intended to fall within the scope of the present invention.

In the embodiments, examples in which an XML document is processed has been mentioned; however, the document processing apparatus 100 of the present embodiments can process a document described in other markup languages, for example, SGML, HTML etc., as well.

1. A data processing apparatus comprising:
a rule acquisition unit that acquires a rule by which a correspondence relation between a pattern of data described in a markup language and a pattern of data described or not described in a markup language, is defined;
a data acquisition unit that acquires data to be compared; and
a matching unit that selects a pattern consistent with the data to be compared,
wherein the matching unit selects, when a variable is included in the pattern, a pattern in which, among the pattern, data other than the variable are consistent with the data to be compared, and
the processing apparatus further comprising a variable control unit that substitutes, when the pattern including the variable is selected, the data to be compared located at a position corresponding to a position of the variable in the selected pattern, into the variable, and
wherein, when the data to be compared is data described in a markup language, and when the data to be compared located at the position corresponding to the position of the variable in the selected pattern is a fragment including a plurality of nodes, the variable control unit substitutes the fragment into the variable.

2. The data processing unit according to claim 1, wherein, when a plurality of homogeneous or heterogeneous data, which can be substituted into the variable, are located in parallel at the position of the data to be compared, which corresponds to the position of the variable in the selected pattern, the variable control unit stores the plurality of data in the variable as a list.

3. The data processing apparatus according to claim 2, wherein, when the data to be compared is data described in a markup language, and when a node located at the position of the data to be compared, which corresponds to the position of the variable in the selected pattern, has a plurality of brother nodes, the variable control unit stores the nodes or fragments in which the nodes are apex nodes, in the variable as a list.

4. The data processing apparatus according to claim 2, wherein, when the variable is attached with a wild card indicating that the variable is to be matched to a plurality of arbitrary data, the variable control unit stores the plurality of data thus matched in the variable as a list.

5. The data processing apparatus according to claim 1, wherein, when the variable is attached with a wild card indicating that the variable is to be matched to arbitrary data not including a text node among the fragment, the variable control unit substitutes data excluding the text data among the fragment thus matched into the variable, and wherein, when the variable is attached with a wild card indicating the variable is to be matched to the arbitrary fragment including a text node as well, the variable control unit substitutes the fragment thus matched in the variable.

6. The data processing apparatus according to claim 1, further comprising a namespace control unit that compares, when the matching unit compares elements or attributes described in a markup language to each other, namespaces of the elements or the attributes to each other, and
wherein, when the namespaces of the elements or the attributes are determined not to be consistent with each other by the namespace control unit, the matching unit determines that the elements or the attributes are not consistent with each other.

7. The data processing apparatus according to claim 1, further comprising a conversion unit that converts the data to be compared, to data with a pattern corresponding to the selected pattern.

8. The data processing apparatus according to claim 7, wherein, among the rule, at least one definition of the correspondence relation includes the same variable in the two corresponding patterns, and wherein the data to be compared is converted to data having a pattern different from that of the data to be compared and including at least part of the data to be compared, by substituting data included in the data to be compared in the variable.

9. The data processing apparatus according to claim 1, further comprising a set operation unit, wherein, when a variable in which a set of a plurality of values is included, is included in the pattern described in a markup language, and when processing to be executed in common for each of the plurality of values is described in a syntax with a form of describing processing for the variable, the set operation unit executes the processing for each of the plurality of values.

10. The data processing apparatus according to claim 9, wherein multiplicity of execution of the processing in parallel can be described in the syntax, and wherein, when the multiplicity of the processing is described in the pattern, the set operation unit executes the processing in parallel as many as described in the multiplicity.

11. The data processing apparatus according to claim 9, wherein a condition for initiating execution of the processing can be described in the syntax, and wherein, when the condition is described in the pattern, the set operation unit executes the processing after waiting until the condition is satisfied.

12. A data processing method comprising:
acquiring a rule by which a correspondence relation between a pattern of data described in a markup language and a pattern of data described or not described in a markup language, is defined;
acquiring data to be compared;
selecting a pattern consistent with the data to be compared;
selecting a pattern in which, among the pattern, data other than the variable are consistent with the data to be compared, when a variable is included in the pattern;
substituting, when the pattern including the variable is selected, the data to be compared located at a position corresponding to a position of the variable in the selected pattern, into the variable; and
substituting, when the data to be compared is data described in a markup language, and when the data to be compared located at the position corresponding to the position of the variable in the selected pattern, is a fragment including a plurality of nodes, the fragment into the variable.

13. A computer program product comprising:
a module that acquires a rule by which a correspondence relation between a pattern of data described in a markup language and a pattern of data described or not described in a markup language, is defined;
a module that acquires data to be compared;
a module that selects a pattern consistent with the data to be compared;
a module that selects a pattern in which, among the pattern, data other than the variable are consistent with the data to be compared, when a variable is included in the pattern;
a module that substitutes, when the pattern including the variable is selected, the data to be compared located at a position corresponding to a position of the variable into the selected pattern; and
a module that substitutes, when the data to be compared is data described in a markup language, and when the data to be compared located at the position corresponding to the position of the variable in the selected pattern, is a fragment including a plurality of nodes, the fragment into the variable.
